(19) United States
(12) Patent Application Publication
(10) Pub. No.: US 2023/0239450 A1
(43) Pub. Date: Jul. 27, 2023

(54) STEREOSCOPIC IMAGE GENERATION BOX, STEREOSCOPIC IMAGE DISPLAY METHOD AND STEREOSCOPIC IMAGE DISPLAY SYSTEM

(71) Applicant: Acer Incorporated, New Taipei City (TW)

(72) Inventors: Wen-Cheng Hsu, New Taipei City (TW); Chao-Kuang Yang, New Taipei City (TW)

(73) Assignee: Acer Incorporated, New Taipei City (TW)

(21) Appl. No.: 18/096,767

(22) Filed: Jan. 13, 2023

(30) Foreign Application Priority Data
Jan. 22, 2022 (TW) 111102763

(51) Int. Cl. H04N 13/139; H04N 13/271; H04N 13/302; H04N 13/383; H04N 13/156; H04N 13/194

(52) U.S. Cl. CPC H04N 13/139; H04N 13/156; H04N 13/194; H04N 13/271; H04N 13/302; H04N 13/383; H04N 2013/0081

(57) ABSTRACT

A stereoscopic image generation box, a stereoscopic image display method and a stereoscopic image display system are provided. The stereoscopic image generation box includes an image receiving and detecting unit, a depth information analysis unit, an image processing unit, a synthesis unit and a data transmission unit. The image receiving and detecting unit is used for receiving a two-dimensional image from an image source. The depth information analysis unit is used for obtaining a depth information according to the two-dimensional image. The image processing unit is used for converting the two-dimensional image into a left-eye image and a right-eye image according to the depth information. The synthesizing unit is used for synthesizing the left-eye image and the right-eye image to generate a stereoscopic image. The data transmission unit is used for outputting the stereoscopic image to a display, so that the display can directly display the stereoscopic image.

This application claims the benefit of Taiwan application Serial No. 111102763, filed Jan. 22, 2022, the subject matter of which is incorporated herein by reference.

### BACKGROUND OF THE INVENTION

### Field of the Invention

The invention relates in general to an image box, a display method and a display system, and more particularly to a stereoscopic image generation box, a stereoscopic image display method and a stereoscopic image display system.

### Description of the Related Art

Along with the continuous advance in the display technology, various stereoscopic display technologies are provided. Despite many notebook computers or mobile phones are equipped with stereoscopic display function, available image resources are limited. Since these electronic devices with computing ability are only equipped with image outputting function but lack image inputting function, an image capture box is required if these electronic devices need to obtain multi-media audio/video resources from a device such as game console or a multi-media player.

During the transmission process, existing image capture box needs to execute a compression procedure and a decompression procedure, hence easily leading to frame delay which affects the effect of stereoscopic display.

### SUMMARY OF THE INVENTION

The invention is directed to a stereoscopic image generation box, a stereoscopic image display method and a stereoscopic image display system. Under the circumstance where image resource is limited, the stereoscopic image generation box of the present embodiment can be linked to various image sources 100 and output converted stereoscopic image, so that the scope of application of stereoscopic display technology can be greatly increased. Besides, during the transmission process, the stereoscopic image generated by the stereoscopic image generation box does not need to execute a compression procedure or a decompression procedure, so that frame delay can be avoided.

According to one embodiment of the present invention, a stereoscopic image generation box is provided. The stereoscopic image generation box includes an image receiving and detecting unit, a depth information analysis unit, an image processing unit, a synthesis unit and a data transmission unit. The image receiving and detecting unit is used for receiving a two-dimensional image from an image source. The depth information analysis unit is used for obtaining a depth information according to the two-dimensional image. The image processing unit is used for converting the two-dimensional image into a left-eye image and a right-eye image according to the depth information. The synthesis unit is used for synthesizing the left-eye image and the right-eye image to generate a stereoscopic image. The data transmission unit is used for outputting the stereoscopic image to a display, so that the display can directly display the stereoscopic image.

According to another embodiment of the present invention, a stereoscopic image display method is provided. The stereoscopic image display method includes the following steps. A two-dimensional image is received from an image source by a stereoscopic image generation box. A depth information is obtained by the stereoscopic image generation box according to the two-dimensional image. The two-dimensional image is converted into a left-eye image and a right-eye image by the stereoscopic image generation box according to the depth information. The left-eye image and the right-eye image are synthesized by the stereoscopic image generation box to generate a stereoscopic image. The stereoscopic image is outputted to a display by the stereoscopic image generation box, so that the display can directly display the stereoscopic image

According to an alternate embodiment of the present invention, a stereoscopic image display system is provided. The stereoscopic image display system includes a stereoscopic image generation box and a display. The stereoscopic image generation box includes an image receiving and detecting unit, a depth information analysis unit, an image processing unit, a synthesis unit and a data transmission unit. The image receiving and detecting unit is used for receiving a two-dimensional image from an image source. The depth information analysis unit is used for obtaining a depth information according to the two-dimensional image. The image processing unit is used for converting the two-dimensional image into a left-eye image and a right-eye image according to the depth information. The synthesis unit is used for synthesizing the left-eye image and the right-eye image to generate a stereoscopic image. The data transmission unit is used for outputting the stereoscopic image. The display is used for receiving the stereoscopic image and can directly display the stereoscopic image.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a stereoscopic image display system according to an embodiment.

FIG. 2 is a block diagram of a stereoscopic image display system according to an embodiment.

FIG. 3 is a flowchart of a stereoscopic image display method according to an embodiment.

FIG. 4 exemplifies a two-dimensional image.

FIG. 5 exemplifies a depth information.

FIG. 6 exemplifies a left-eye image and the right-eye image.

FIG. 7 exemplifies a stereoscopic image.

FIG. 8 is a schematic diagram of a stereoscopic image display system according to an embodiment.

FIG. 9 is a block diagram of a stereoscopic image display system according to an embodiment.

FIG. 10 is a flowchart of a stereoscopic image display method according to an embodiment.

FIG. 11 exemplifies a stereoscopic image.

### DETAILED DESCRIPTION OF THE INVENTION

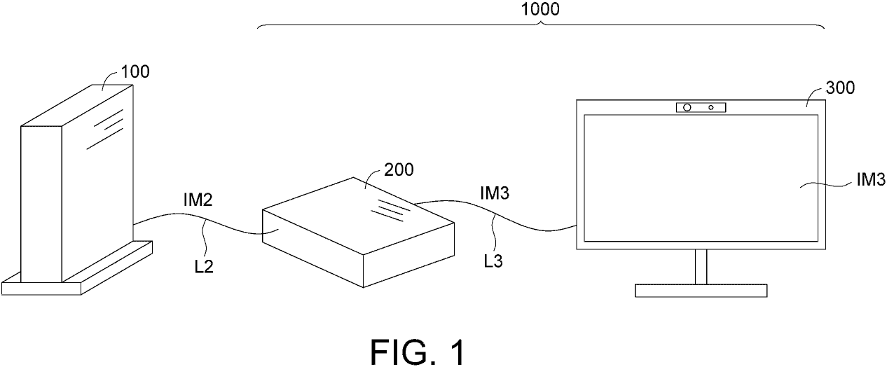

Referring to FIG. 1, a schematic diagram of a stereoscopic image display system 1000 according to an embodiment is shown. The stereoscopic image display system 1000 includes a stereoscopic image generation box 200 and a display 300. The stereoscopic image generation box 200 and the display 300 are two separate and independent electronic devices. The stereoscopic image generation box 200 is used for converting the two-dimensional image IM2 provided by the image source 100 into a stereoscopic image IM3. The image source 100 can be realized by such as a game console or a multimedia player. The stereoscopic image generation box 200 and the image source 100 are linked through an image transmission line L2. The image transmission line L2 can be realized by such as a VGA transmission line, a DVI transmission line, an HDMI transmission line or a DP transmission line. The two-dimensional image IM2 can be realized by such as a single frame. In another embodiment, the two-dimensional image IM2 can be a particular frame in a particular streaming. The stereoscopic image generation box 200 has graphics computing ability. The stereoscopic image generation box 200 also can continuously process each frame in the particular streaming.

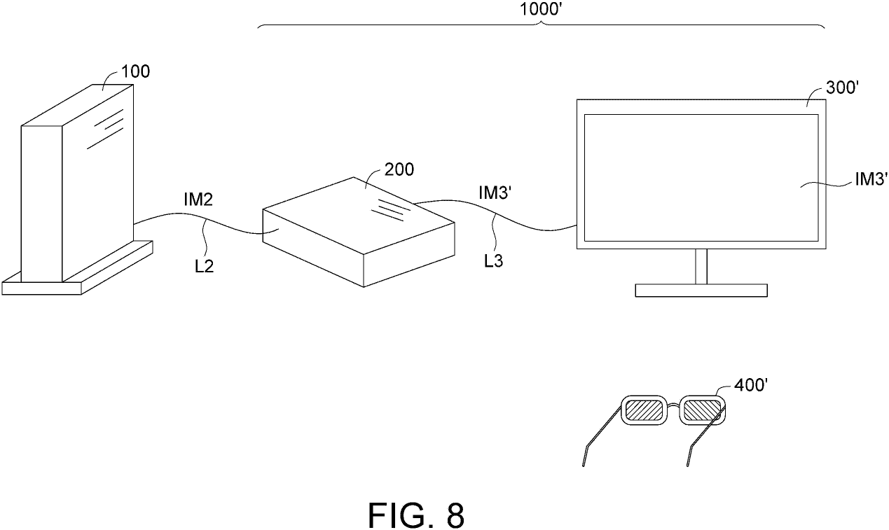

After generating the stereoscopic image IM3, the stereoscopic image generation box 200 directly transmits the stereoscopic image IM3 to the display 300, so that the display 300 can directly display the stereoscopic image IM3. The stereoscopic image generation box 200 and the display 300 are linked through a data transmission line L3. The data transmission line L3 can be realized by such as a USB Type C cable or a USB Type A cable. The display 300 can be realized by such as a naked eye stereoscopic display of a notebook computer or a naked eye stereoscopic display of a mobile phone. In other embodiments, the present technology can also be used in an ordinary display not equipped with naked eye stereoscopic display function, and the implementations are illustrated with FIGS. 8 to 10. Here below, details of the present technology used in the display 300 equipped with naked eye stereoscopic display function are illustrated with FIGS. 1 to 7.

Since the stereoscopic image generation box 200 and the display 300 can be linked through a data transmission line L3, the stereoscopic image generation box 200 of the present disclosure can also be used in electronic devices not equipped with image input function such as a notebook computer or a mobile phone.

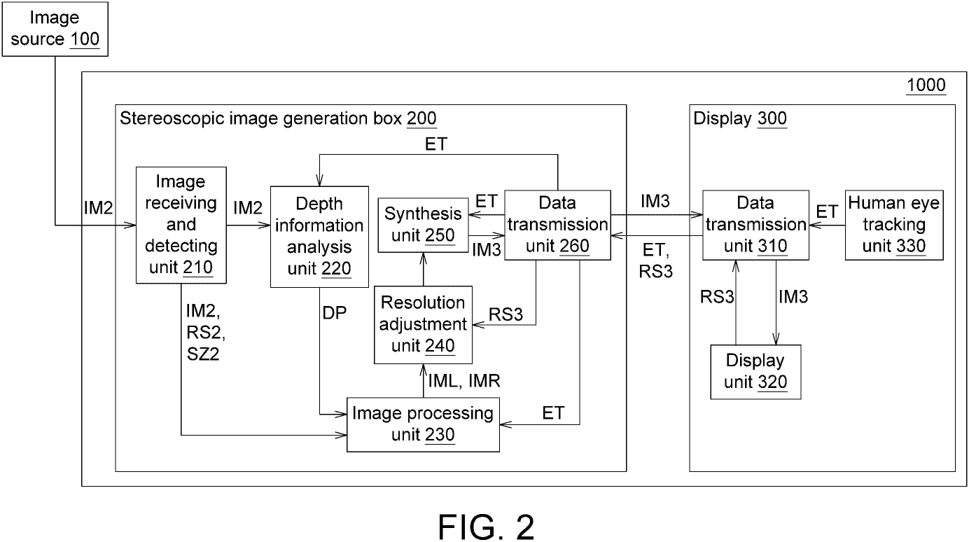

Referring to FIG. 2, a block diagram of a stereoscopic image display system 1000 according to an embodiment is shown. The stereoscopic image generation box 200 includes an image receiving and detecting unit 210, a depth information analysis unit 220, an image processing unit 230, a resolution adjustment unit 240, a synthesis unit 250 and a data transmission unit 260. The function of each element is briefly disclosed below. The image receiving and detecting unit 210 is used for receiving and detecting images and can be realized by such as an image transmission interface or an image transmission module. The depth information analysis unit 220 is used for analyzing the depth information. The image processing unit 230 is used for converting images. The resolution adjustment unit 240 is used for adjusting resolution. The synthesis unit 250 is used for synthesizing images. The depth information analysis unit 220, the image processing unit 230, the resolution adjustment unit 240 and the synthesis unit 250 can be realized by such as a circuit, a circuit board, a chip, a computer code or a recording medium for storing computer code. The data transmission unit 260 is used for transmitting data and can be realized by such as a data transmission interface.

The display 300 includes a data transmission unit 310, a display unit 320 and a human eye tracking unit 330. The data transmission unit 310 is used for transmitting data and can be realized by such as a data transmission interface. The display unit 320 is used for displaying frames and can be composed of a display panel and a lenticular lens or of a display panel and a slit grating. The human eye tracking unit 330 is used for tracking the position of human eye and can be composed of a camera and an image recognition circuit.

The stereoscopic image generation box 200 of the present embodiment can convert the two-dimensional image IM2 into a stereoscopic image IM3 by using the depth information analysis unit 220, the image processing unit 230, the synthesis unit 250. During the transmission process, the stereoscopic image IM3 generated by the stereoscopic image generation box 200 does not need to execute any compression or decompression procedures, so that frame delay can be avoided. Operations of each element are disclosed below with a flowchart.

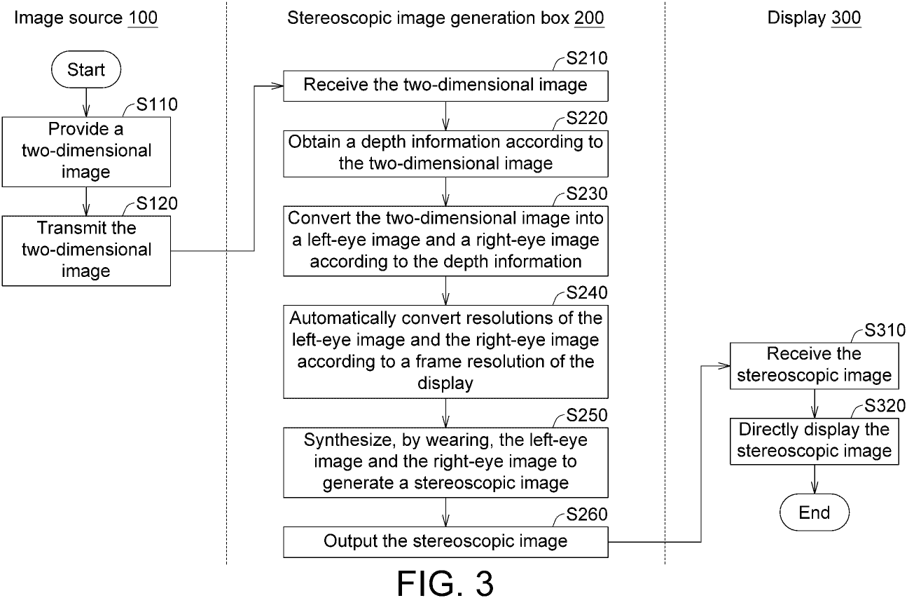

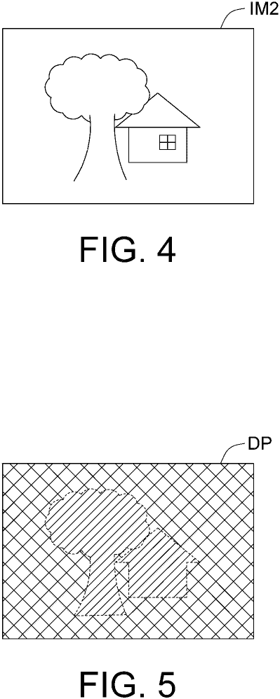

Refer to FIG. 2 and FIG. 3. FIG. 3 is a flowchart of a stereoscopic image display method according to an embodiment. In step S110, a two-dimensional image IM2 is provided by an image source 100. Referring to FIG. 4, a two-dimensional image IM2 is exemplified. The two-dimensional image IM2 can be realized by such as a real-time frame of a game played by a user or a film frame of a video player. The two-dimensional image IM2 can be a frame of one of the continuous images.

Next, the method proceeds to step S120, a two-dimensional image IM2 is transmitted by the image source 100.

Then, the method proceeds to step S210, the two-dimensional image IM2 is received by the image receiving and detecting unit 210 of the stereoscopic image generation box 200. In the present step, the image receiving and detecting unit 210 further detects an image resolution RS2 of the image source 100. In another embodiment, the image receiving and detecting unit 210 can further detect an image size SZ2 of the image source 100.

Then, the method proceeds to step S220, a depth information DP is obtained by the depth information analysis unit 220 of the stereoscopic image generation box 200 according to the two-dimensional image IM2. Referring to FIG. 5, a depth information DP is exemplified. The depth information analysis unit 220 can analyze the depth information DP using an AI algorithm. Or, the depth information analysis unit 220 can analyze the depth information DP with reference to a human eye tracking information ET. Or, the depth information analysis unit 220 can directly obtain the left eye depth information and the right eye depth information. The present technology does not specify the method for obtaining the depth information DP.

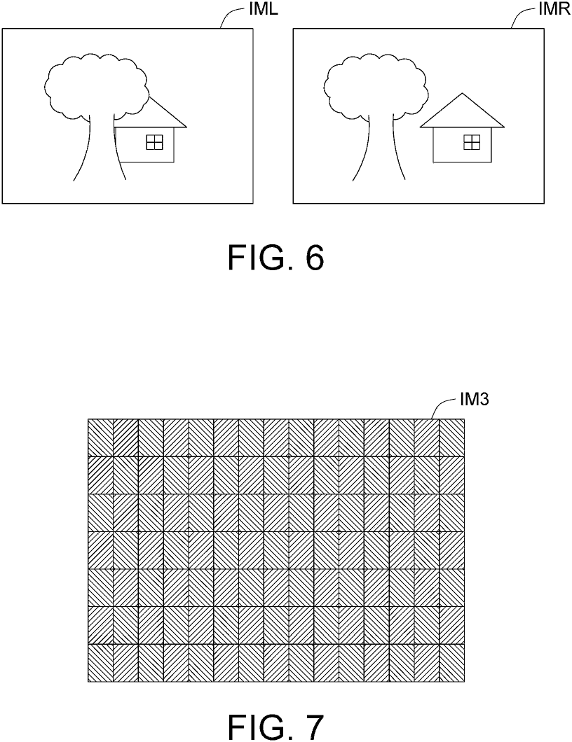

Then, the method proceeds to step S230, the two-dimensional image IM2 is converted into a left-eye image IML and a right-eye image IMR by the image processing unit 230 of the stereoscopic image generation box 200 according to the depth information DP. Referring to FIG. 6, a left-eye image IML and a right-eye image IMR are exemplified. The left-eye image IML is an image viewed from the angle of the left eye; the right-eye image IMR is an image viewed from the angle of the right eye. When two objects are at different depths, the overlapping of the two objects on the image viewed from the angle of the left eye will be different from that viewed from the angle of the right eye.

In the present step, the image processing unit 230 can select processing chips according to the image resolution RS2 to convert the two-dimensional image IM2 into a left-eye image IML and a right-eye image IMR. When the image resolution RS2 is higher, the image processing unit 230 can select processing chips with better performance; when the image resolution RS2 is lower, the image processing unit 230 can select processing chips with lower performance, so that best energy efficiency can be achieved.

Or, the image processing unit 230 can select processing chips according to the image resolution RS2 and the image size SZ2 to convert the two-dimensional image IM2 into a left-eye image IML and a right-eye image IMR. When the image resolution RS2 is higher or the image size SZ2 is larger, the image processing unit 230 can select processing chips with better performance; when image resolution RS2 is lower and the image size SZ2 is smaller, the image processing unit 230 can select processing chips with lower performance, so that best energy efficiency can be achieved.

In an embodiment, the image processing unit 230 can also convert the two-dimensional image IM into a left-eye image IML and a right-eye image IMR with reference to the human eye tracking information ET. The present technology does not specify the method for converting the left-eye image IML and the right-eye image IMR.

Then, the method proceeds to step S240, resolutions of the left-eye image IML and the right-eye image IMR are automatically converted by the resolution adjustment unit 240 of the stereoscopic image generation box 200 according to a frame resolution RS3 of the display 300. For instance, when the frame resolution RS3 is higher, the resolution adjustment unit 240 can execute a pixel offset procedure to increase the resolution; when the frame resolution RS3 is lower, the resolution adjustment unit 240 can execute a pixel filtering procedure to reduce the resolution. In an embodiment, step S240 can be omitted.

Then, the method proceeds to step S250, the left-eye image IML and the right-eye image IMR are synthesized by the synthesis unit 250 of the stereoscopic image generation box 200 to generate a stereoscopic image IM3. In an embodiment where the display 300 is a naked eye stereoscopic display, the synthesis unit 250 wears the left-eye image IML and the right-eye image IMR according to the human eye tracking information ET to generate the stereoscopic image IM3. Referring to FIG. 7, a stereoscopic image IM3 is exemplified. In FIG. 7, the top left to bottom right slash can be realized by such as the contents of a left-eye image IML; the top right to bottom left slash can be realized by such as the contents of a right-eye image IMR. FIG. 7 is only an exemplification of synthesis method, not for limiting the scope of application of the present technology.

Then, the method proceeds to step S260, the stereoscopic image IM3 is outputted by the data transmission unit 260 of the stereoscopic image generation box 200. Before outputting the stereoscopic image IM3, the stereoscopic image generation box 200 does not execute any compression procedure on the stereoscopic image IM3 but directly outputs the stereoscopic image IM3 through a data transmission line L3 (illustrated in FIG. 1).

Then, the method proceeds to step S310, the stereoscopic image IM3 is received by the data transmission unit 310 of the display 300.

Then, the method proceeds to step S320, the stereoscopic image IM3 is directly displayed by the display unit 320 of the display 300. After receiving the stereoscopic image IM3, the display 300 does not need to perform any decompression procedure.

In the streaming application, the image source 100 continuously inputs the two-dimensional image IM2 to the stereoscopic image generation box 200. Each frame of the two-dimensional image IM2 is converted and then is continuously outputted to the stereoscopic image IM3 to be continuously displayed on the display 300.

According to the above embodiments, under the circumstance where image resource is limited, the stereoscopic image generation box 200 of the present embodiment can be linked to various image sources 100 and output converted stereoscopic image IM3, so that the scope of application of stereoscopic display technology can be greatly increased.

Besides, during the transmission process, the stereoscopic image IM3 generated by the stereoscopic image generation box 200 does not need to execute any compression or decompression procedures, so that frame delay can be avoided.

Apart from the previous embodiment, the present technology can also be used in an ordinary display not equipped with naked eye stereoscopic display function, details of implementations are disclosed in FIGS. 8 to 10, and the similarities are not repeated.

Referring to FIG. 8, a schematic diagram of a stereoscopic image display system 1000′ according to an embodiment is shown. The stereoscopic image display system 1000′ includes a stereoscopic image generation box 200 and a display 300′. The stereoscopic image generation box 200 and the display 300′ are two separate and independent electronic devices. The stereoscopic image generation box 200 is used for converting the two-dimensional image IM2 provided by the image source 100 into a stereoscopic image IM3′.

After generating the stereoscopic image IM3′, the stereoscopic image generation box 200 directly transmits the stereoscopic image IM3′ to the display 300′, so that the display 300′ can directly display the stereoscopic image IM3′. The stereoscopic image generation box 200 and the display 300′ are linked through a data transmission line L3. The display 300′ can be realized by such as a display not equipped with naked eye stereoscopic display function. When the display 300′ displays the stereoscopic image IM3′, the user can view the stereoscopic image IM3′ with a pair of stereoscopic imaging glasses 400′. The pair of stereoscopic imaging glasses 400′ can be realized by such as a pair of chromatic aberration glasses, shutter glasses, or polarized glasses.

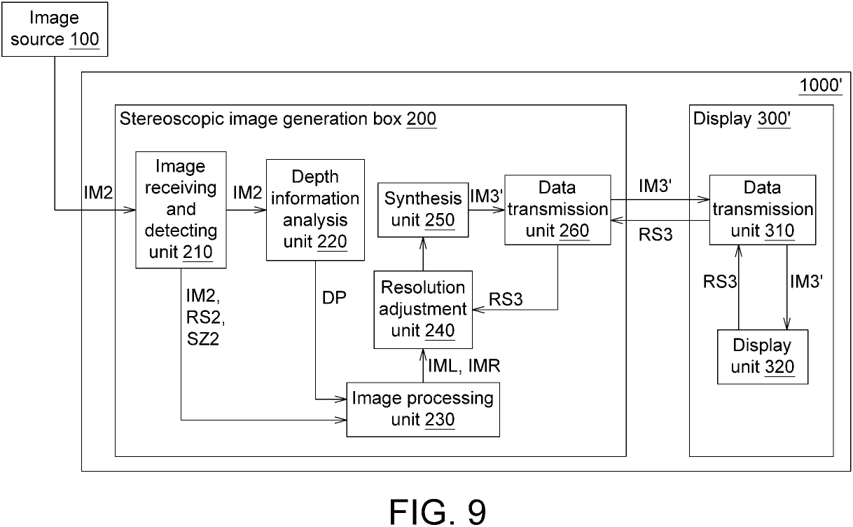

Referring to FIG. 9, a block diagram of a stereoscopic image display system 1000′ according to an embodiment is shown. The display 300′ includes a data transmission unit 310 and a display unit 3200. The stereoscopic image generation box 200 of the present embodiment can convert the two-dimensional image IM2 into a stereoscopic image IM3′ through the use of the depth information analysis unit 220, the image processing unit 230 or the synthesis unit 250. During the transmission process, the stereoscopic image IM3′ generated by the stereoscopic image generation box 200 does not need to execute any compression or decompression procedures, so that frame delay can be avoided. Operations of each element are disclosed below with a flowchart.

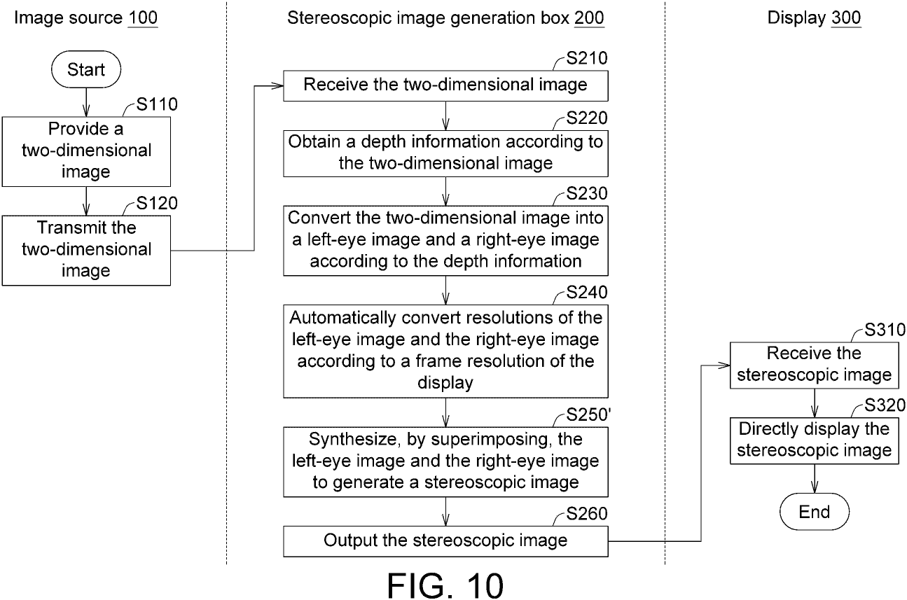

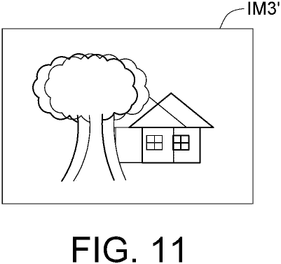

Refer to FIG. 9 and FIG. 10. FIG. 10 is a flowchart of a stereoscopic image display method according to an embodiment. In step S250′, the left-eye image IML and the right-eye image IMR are synthesized by the synthesis unit 250 of the stereoscopic image generation box 200 to generate a stereoscopic image IM3. In the embodiment where the display 300′ is not equipped with naked eye stereoscopic display function, the synthesis unit 250 superimpose the left-eye image IML and the right-eye image IMR according to a human eye tracking information ET to generate a stereoscopic image IM3′. Referring to FIG. 11, a stereoscopic image IM3′ is exemplified. In the example of FIG. 11, the left-eye image IML and the right-eye image IMR are superimposed on the same image in different colors to form the stereoscopic image IM3′. FIG. 11 is only an exemplification of synthesis method, not for limiting the scope of application of the present technology.

In step S320, the stereoscopic image IM3′ can be directly displayed by the display unit 320 of the display 300′. After receiving the stereoscopic image IM3′, the display 300 does not need to perform any decompression procedures.

Each frame of the two-dimensional image IM2 is converted and then is continuously outputted to the stereoscopic image IM3′ and continuously displayed on the display 300′.

According to the above embodiments, under the circumstance where image resource is limited, the stereoscopic image generation box 200 of the present embodiment can be linked to various image sources 100 to output the converted stereoscopic image IM3′, so that the scope of application of stereoscopic display technology can be greatly increased.

Besides, during the transmission process, the stereoscopic image IM3′ generated by the stereoscopic image generation box 200 does not need to execute any compression or decompression procedures, so that frame delay can be avoided.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A stereoscopic image generation box, comprising:
an image receiving and detecting unit, used for receiving a two-dimensional image from an image source;
a depth information analysis unit, used for obtaining a depth information according to the two-dimensional image;
an image processing unit, used for converting the two-dimensional image into a left-eye image and a right-eye image according to the depth information;
a synthesis unit, used for synthesizing the left-eye image and the right-eye image to generate a stereoscopic image; and
a data transmission unit, used for outputting the stereoscopic image to a display, so that the display directly displays the stereoscopic image.

2. The stereoscopic image generation box according to claim 1, further comprising:
a resolution adjustment unit, used for automatically converting resolutions of the left-eye image and the right-eye image according to a frame resolution of the display.

3. The stereoscopic image generation box according to claim 1, wherein the image receiving and detecting unit is further used for detecting an image resolution of the image source; the image processing unit selects processing chips from a plurality of processing chips according to the image resolution to convert the two-dimensional image into the left-eye image and the right-eye image.

4. The stereoscopic image generation box according to claim 3, wherein the image receiving and detecting unit is further used for detecting an image size of the image source; the image processing unit further selects processing chips from the processing chips according to the image size to convert the two-dimensional image into the left-eye image and the right-eye image.

5. The stereoscopic image generation box according to claim 1, wherein the display is a naked eye stereoscopic display; the display detects a human eye tracking information; the synthesis unit wears the left-eye image and the right-eye image according to the human eye tracking information to generate the stereoscopic image.

6. The stereoscopic image generation box according to claim 1, wherein the image receiving and detecting unit and the image source are linked through an image transmission line.

7. The stereoscopic image generation box according to claim 1, wherein the data transmission unit and the display are linked through a data transmission line.

8. A stereoscopic image display method, comprising:
receiving a two-dimensional image from an image source by a stereoscopic image generation box;
obtaining a depth information by the stereoscopic image generation box according to the two-dimensional image;
converting the two-dimensional image into a left-eye image and a right-eye image by the stereoscopic image generation box according to the depth information;
synthesizing the left-eye image and the right-eye image by the stereoscopic image generation box to generate a stereoscopic image; and
outputting the stereoscopic image to a display by the stereoscopic image generation box, so that the display directly displays the stereoscopic image.

9. The stereoscopic image display method according to claim 8, further comprising:
automatically converting resolutions of the left-eye image and the right-eye image by the stereoscopic image generation box according to a frame resolution of the display.

10. The stereoscopic image display method according to claim 8, wherein the stereoscopic image generation box further detects an image resolution of the image source and further selects processing chips from a plurality of processing chips according to the image resolution to convert the two-dimensional image into the left-eye image and the right-eye image.

11. The stereoscopic image display method according to claim 10, wherein the stereoscopic image generation box further detects an image size of the image source and selects processing chips from the processing chips according to the image size to convert the two-dimensional image into the left-eye image and the right-eye image.

12. The stereoscopic image display method according to claim 8, wherein the display is a naked eye stereoscopic display and used for detecting a human eye tracking information; the stereoscopic image generation box wears the left-eye image and the right-eye image according to the human eye tracking information to generate the stereoscopic image.

13. The stereoscopic image display method according to claim 8, wherein the stereoscopic image generation box receives the two-dimensional image from the image source through an image transmission line.

14. The stereoscopic image display method according to claim 8, wherein the stereoscopic image generation box transmits the stereoscopic image to the display through a data transmission line.

15. A stereoscopic image display system, comprising:
a stereoscopic image generation box, comprising:
an image receiving and detecting unit, used for receiving a two-dimensional image from an image source;
a depth information analysis unit, used for obtaining a depth information according to the two-dimensional image;
an image processing unit, used for converting the two-dimensional image into a left-eye image and a right-eye image according to the depth information;
a synthesis unit, used for synthesizing the left-eye image and the right-eye image to generate a stereoscopic image; and
a data transmission unit, used for outputting the stereoscopic image; and
a display, used for receiving the stereoscopic image and directly displaying the stereoscopic image.

16. The stereoscopic image display system according to claim 15, wherein the stereoscopic image generation box further comprises:
a resolution adjustment unit, used for automatically converting resolutions of the left-eye image and the right-eye image according to a frame resolution of the display.

17. The stereoscopic image display system according to claim 15, wherein the image receiving and detecting unit is further used for detecting an image resolution of the image source; the image processing unit selects processing chips from a plurality of processing chips according to the image resolution to convert the two-dimensional image into the left-eye image and the right-eye image.

18. The stereoscopic image display system according to claim 17, wherein the image receiving and detecting unit is further used for detecting an image size of the image source; the image processing unit further selects processing chips from the processing chips according to the image size to convert the two-dimensional image into the left-eye image and the right-eye image.

19. The stereoscopic image display system according to claim 15, wherein the display is a naked eye stereoscopic display; the display detects a human eye tracking information; the synthesis unit wears the left-eye image and the right-eye image according to the human eye tracking information to generate the stereoscopic image.

20. The stereoscopic image display system according to claim 15, wherein the data transmission unit and the display are linked through a data transmission line.
